(19) United States
(12) Patent Application Publication
(10) Pub. No.: US 2017/0061689 A1
(43) Pub. Date: Mar. 2, 2017

(54) SYSTEM FOR IMPROVING OPERATOR VISIBILITY OF MACHINE SURROUNDINGS

(71) Applicant: Caterpillar Inc., Peoria, IL (US)

(72) Inventors: Peter Joseph PETRANY, Dunlap, IL (US); Douglas Jay HUSTED, Secor, IL (US); Rodrigo Lain SANCHEZ, Dunlap, IL (US); Anthony Dean McNEALY, Peoria, IL (US)

(73) Assignee: Caterpillar Inc., Peoria, IL (US)

(21) Appl. No.: 14/833,226

(22) Filed: Aug. 24, 2015

(51) Int. Cl. G06T 19/00; G02B 27/01; G06T 19/20; G06T 7/60; B60R 1/00; G06F 3/01

(52) U.S. Cl. CPC G06T 19/006; B60R 1/00; G06F 3/013; G06T 19/20; G06T 7/60; G02B 27/0101; G06T 2200/04; G02B 2027/0138; G02B 2027/014

(57) ABSTRACT

A system for displaying machine surroundings to an operator in a cab of the machine may include at least one outward-facing camera mounted on the machine. The at least one outward-facing camera may be configured to generate image data for an actual environment surrounding the machine. The system may also include at least one operator-facing camera mounted within the cab of the machine. The at least one operator-facing camera may be configured to determine gaze attributes of the operator. A sensor may be mounted on the machine and configured to generate object data regarding detection and ranging of an object in the actual environment. At least one see-through display may form one or more windows of the cab of the machine, and a processor in communication with the at least one outward-facing camera, the at least one operator-facing camera, and the sensor may be configured to generate a unified image of the actual environment based on the image data, and project the unified image as a 3-D image on the at least one see-through display.

### TECHNICAL FIELD

This disclosure relates generally to image processing systems and methods and, more particularly, to image processing systems and methods for improving operator visibility of machine surroundings.

### BACKGROUND

Various machines such as excavators, scrapers, articulated trucks and other types of heavy equipment are used to perform a variety of tasks. Some of these tasks involve moving large, awkward, and heavy loads in close proximity to other machines, terrain changes, objects, and personnel. And because of the size of the machines and/or the poor visibility provided to operators of the machines, these tasks can be difficult to complete safely and effectively. For this reason, some machines are equipped with image processing systems that provide views of the machines' environments to their operators.

Such image processing systems assist the operators of the machines by increasing visibility, and may be beneficial in situations where the operators' fields of view are obstructed by portions of the machines or other obstacles. Conventional image processing systems include cameras that capture different areas of a machine's environment. These areas may then be stitched together to form a partial or complete view of the environment around the machine. Some image processing systems use a top-view transformation on the captured images to display a representative view of the associated machine at a center of the display (known as a “bird's eye view”). While effective, these types of systems can also include image distortions that increase in severity the further that objects in the captured image are away from the machine.

One attempt to reduce image distortions in the views provided to a machine operator is disclosed in U.S. Patent Application Publication 2014/0204215 of Kriel at al., which published on Jul. 24, 2014 (the '215 publication). In particular, the '215 publication discloses an image processing system having a plurality of cameras and a display that are mounted on a machine. The cameras generate image data for an environment of the machine. The image processing system also has a processor that generates a unified image of the environment by combining image data from each of the cameras and mapping pixels associated with the data onto a hemispherical pixel map. In the hemispherical pixel map, the machine is located at the pole. The processor then sends selected portions of the hemispherical map to be shown inside the machine on the display.

While the system of the '215 publication may reduce distortions by mapping the data pixels onto a hemispherical map, the system may still be improved upon. In particular, the system may still show distortions of the environment at locations of large objects in the environment. The system also requires the operator to wear cumbersome glasses when looking at a display for the unified image information, and does not solve the problem of perceived distortions in the image created by parallax and perspective shift. Additionally, a system such as the system of the '215 publication could be further improved by features that enhance the visibility of any persons positioned near the machine.

The disclosed system is directed to overcoming one or more of the problems set forth above and/or other problems of the prior art.

### SUMMARY

In one aspect, the present disclosure is directed to a system for displaying machine surroundings to an operator in a cab of the machine. The system may include at least one outward-facing camera mounted on the machine. The at least one outward-facing camera may be configured to generate image data for an actual environment surrounding the machine. The system may also include at least one operator-facing camera mounted within the cab of the machine. The at least one operator-facing camera may be configured to determine gaze attributes of the operator. A sensor may be mounted on the machine and configured to generate object data regarding detection and ranging of an object in the actual environment. At least one see-through display may form one or more windows of the cab of the machine, and a processor in communication with the at least one outward-facing camera, the at least one operator-facing camera, and the sensor may be configured to generate a unified image of the actual environment based on the image data, and project the unified image as a 3-D image on the at least one see-through display.

In another aspect, the present disclosure is directed to a method of displaying machine surroundings to an operator in a cab of the machine. The method may include generating image data for an actual environment surrounding the machine using at least one outward-facing camera mounted on the machine, determining gaze attributes of the operator using at least one operator-facing camera mounted within the cab of the machine, and generating object data indicative of detection and range of an object in the actual environment using a sensor mounted on the machine. The method may also include generating a unified image of the actual environment based on the image data using a processor communicatively coupled to the at least one outward-facing camera, the at least one operator-facing camera, and the sensor. The method may still further include projecting the unified image as a 3-D image on at least one see-through display forming one or more windows of the cab of the machine.

In yet another aspect, the present disclosure is directed to a computer readable medium having executable instructions stored thereon for completing a method of displaying machine surroundings to an operator in a cab of the machine. The method may include generating image data for an actual environment surrounding the machine using at least one outward-facing camera mounted on the machine, determining gaze attributes of the operator using at least one operator-facing camera mounted within the cab of the machine, and generating object data indicative of detection and range of an object in the actual environment using a sensor mounted on the machine. The method may also include generating a unified image of the actual environment based on the image data, the gaze attributes of the operator, and the object data. The method may still further include projecting the unified image as a 3-D image on at least one see-through display forming one or more windows of the cab of the machine.

### BRIEF DESCRIPTION OF THE DRAWINGS

FIG. 1 is a pictorial illustration of an exemplary disclosed machine; and

FIG. 2 is a diagrammatic illustration of an exemplary disclosed vision enhancement system that may be used in conjunction with the machine of FIG. 1.

### DETAILED DESCRIPTION

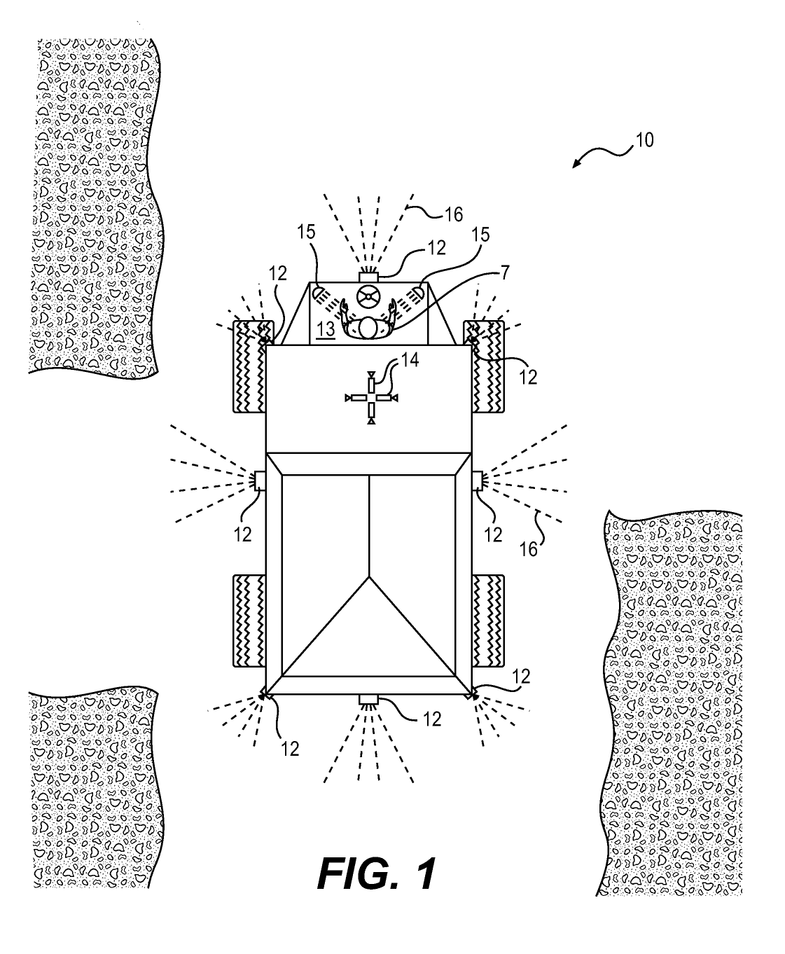

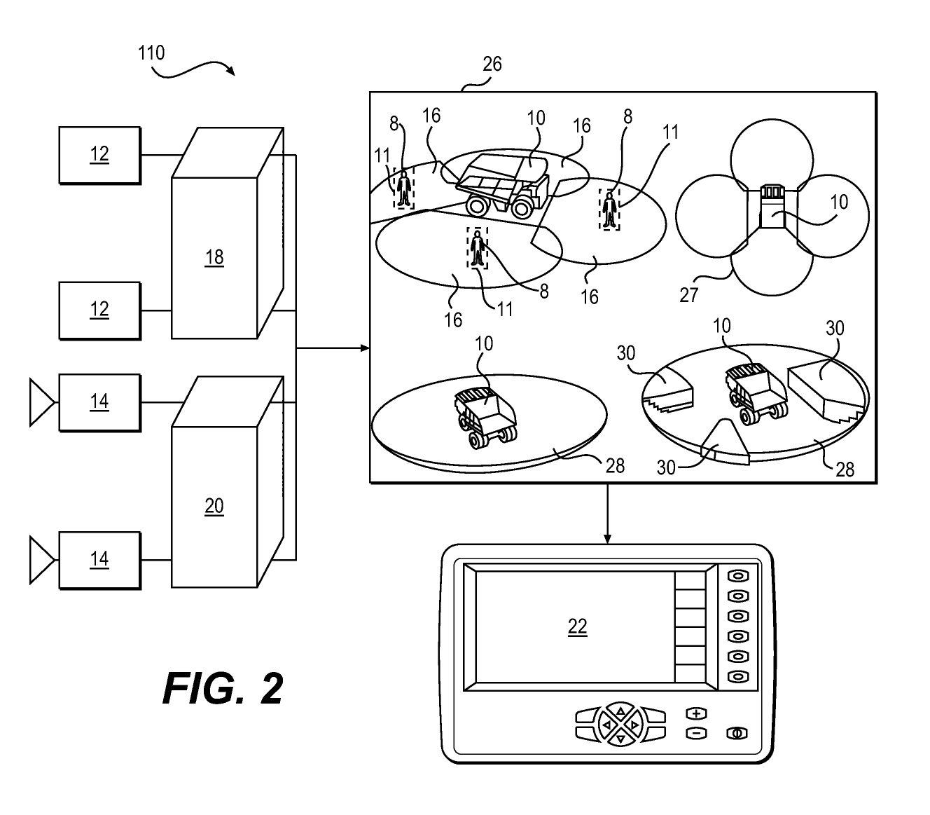

FIG. 1 illustrates an exemplary machine 10 having multiple systems and components that cooperate to accomplish a task. The machine 10 may embody a mobile machine or vehicle that performs some type of operation associated with an industry such as mining, construction, farming, transportation, or any other industry known in the art. For example, the machine 10 may be an earth moving machine such as a haul truck (shown in FIG. 1), an excavator, a dozer, a loader, a backhoe, a motor grader, or any other earth moving machine. The machine 10 may include a vision enhancement system (VES) 110 (see FIG. 2), which may include one or more detection and ranging devices (“devices”) 12, any number of outward-facing cameras 14, one or more operator-facing cameras 15, a detection and ranging interface 18, a camera interface 20, and a processor 26. In addition, the VES 110 may include any number of image projectors and see-through displays in a cab 13 of the machine 10. The VES 110 may be active during operation of the machine 10, for example as the machine 10 moves about an area to complete its assigned tasks such as digging, hauling, dumping, ripping, shoveling, or compacting different materials. Reference to “cameras” herein includes any of optical devices, lens, charge coupled devices (CCD), complementary metal-oxide-semiconductor (CMOS) detector arrays and driving circuitry, and other arrangements of optical components, electronic components, and control circuitry used in transmitting and receiving light of various wavelengths.

The machine 10 may use the devices 12 to generate object data associated with objects in their respective fields of view 16. The devices 12 may each be any type of sensor known in the art for detecting and ranging (locating) objects. For example, the devices 12 may include radio detecting and ranging (RADAR) devices, sound navigation and ranging (SONAR) devices, light detection and ranging (LIDAR) devices, radio-frequency identification (RFID) devices, cameras, and/or global position satellite (GPS) devices used to detect objects in the actual environment of the machine 10. During operation of the machine 10, the detection and ranging interface 18 may process the object data received from these devices 12 to size and range (i.e., to locate) the objects.

The outward-facing camera(s) 14 may be attached to the frame of the machine 10 at any desired location, for example at a high vantage point near an outer edge of the machine 10. The machine 10 may use the outward-facing camera(s) 14 to generate image data associated with the actual environment in their respective fields of view 16. The images may include, for example, video or still images. During operation, the camera interface 20 may process the image data in preparation for presentation on one or more displays 22 (e.g., a 2-D or 3-D monitor) located inside the machine 10. Although FIG. 2 illustrates the display 22 as a stand-alone device, in various implementations of this disclosure the display 22 may comprise one or more entire or partial interior walls or glass windows of a cab 13.

The glass windows forming one or more walls of the cab 13 may comprise see-through displays. The glass windows of the cab 13 may form see-through displays at least partially surrounding the operator 7, with the glass used in the windows including, for example, various impurities or other characteristics that enable the glass to reflect certain wavelengths of light. One or more image projectors mounted within the cab 13 and controlled by the VES 110 may be configured to project multiple images taken from multiple perspectives onto the see-through displays in order to render a 3-D image to the operator. At the same time, the see-through display glass windows allow the operator to directly observe the environment outside of the windows.

One or more operator-facing cameras 15 may be mounted in the cab 13 in which an operator 7 is sitting. The operator-facing cameras 15 may be configured to determine the direction of the gaze or other gaze attributes of the operator 7. Various techniques that may be employed by the operator-facing cameras 15 in conjunction with the camera interface 20 may include emitting a pupil-illuminating light beam directed at the pupil of an eye of the operator 7. Another reference light beam may also be directed at the face and/or head of the operator 7. An image detector of the operator-facing camera in conjunction with the camera interface 20 may be configured to receive reflected portions of the pupil-illuminating light beam and the reference light beam, and determine a line of sight of the operator through a comparison of the reflected portions of the light beams.

Presentation of the images and/or data supplied by the outward-facing cameras 14 and the devices 12 on the see-through display 22 may include projecting the images and/or data on at least portions of the interior walls and/or see-through glass windows of the cab 13. The projected images may provide the operator 7 with a complete, three dimensional (3-D), surround view of the environment around the cab. The projected 3-D images may also give the operator the perception of being able to see through portions of the machine that would normally block the operator's view. In some implementations the operator 7 may also wear polarized, stereovision glasses, which may enable or enhance the 3-D effect such that the portions of the environment observed on the see-through displays appear to be at their actual distance from the cab 13. The effect of projecting 3-D images on the proper portions of the see-through displays in the cab 13 as determined by the gaze direction or other gaze attributes of the operator 7 at any particular point in time enhances realism and improves the presentation of actionable information to the operator. A perceived 3-D image projected on the see-through displays avoids the operator's eyes having to refocus to see the image on the display while also looking through the see-through display in the operator's line of sight outside of the cab. The effect is that when an operator looks out of a window of the cab in the direction of an object or personnel blocked from view by a portion of the machine, the operator will see an image of the object or personnel as though actually seeing through the machine. In various implementations the operator may still perceive the blocking portion of the machine, which may appear greyed-out or at least semi-translucent or semi-transparent, while also seeing the 3-D image of the object or personnel that is behind the blocking portion in the operator's line of sight.

In various implementations, the VES 110 may include one or more GPS devices, a wireless communication system, one or more heads-up displays (HUD), a graphics projection system, and an occupant eye location sensing system (including the operator-facing cameras 15). The VES 110 may communicate directly with various systems and components on the machine 10. The VES 110 may alternatively or additionally communicate over a LAN/CAN system. The VES 110 may communicate with the graphics projection system in order to project graphics upon the see-through display(s) formed by one or more of the windows of the cab. Additionally or alternatively, the VES 110 may project graphics and images upon other surfaces within the cab of the machine, such as structural support pillars, the floor of the cab, and/or the ceiling of the cab. The VES 110 may receive user inputs provided to a portion of one or more of the display devices, including signals indicative of the direction in which the operator is looking at any particular time. The VES 110 may also be configured to include personnel classification software. The personnel classification software may be configured to associate bounding boxes 11 or other identification markers or highlights with any personnel 8 located in proximity to the machine 10 such that the operator 7 of the machine 10 will be provided with enhanced visibility of anyone who comes close to the machine.

The devices 12 may be configured to employ electromagnetic radiation to detect other machines or objects located near the machine. Other proximity sensing devices may also be included. A number of in-machine sensors may be included to monitor machine speed, engine speed, wheel slip, and other parameters characteristic of the operation of the machine. Machine speed sensors, acceleration sensors, braking sensors, turning sensors, and other sensors configured to generate signals indicative of movement of the machine may also provide input to the VES 110. One or more GPS devices and a wireless communication system may communicate with resources outside of the machine, for example, a satellite system and a cellular communications tower. The one or more GPS devices may be utilized in conjunction with a 3-D map database including detailed information relating to a global coordinate received by a GPS device regarding the current location of the machine 10. Information from the machine sensor systems and the machine operation sensors can be utilized by the VES 110 to monitor the current orientation of the machine.

One or more HUD within the cab 13 of the machine 10 may be equipped with features capable of displaying images representative of the environment surrounding the machine 10 while remaining transparent or substantially transparent such that the operator 7 of the machine 10 can clearly observe outside of the windows of the cab while at the same time having the perception of being able to see through obstructing portions of the machine. The one or more HUD may be provided in conjunction with thin film coatings on the see-through glass displays provided as one or more windows of the cab 13. In certain alternative implementations, all or some of the interior surfaces within the cab of the machine may also be used for projection of images, including windows, support pillars, and even the ceiling and floor of the cab. Flexible display surfaces such as Organic Light Emitting Diodes (OLED) or Organic Light Emitting Polymers (OLEP) may be provided over non-transparent surfaces such as the support pillars or the floor of the cab. However, an advantage of projecting a desired image onto a see-through display, such as created by special glass used in the windows of the cab, is the image may provide a 3-D representation of an object or person obscured from direct vision by a portion of the machine. The projection of a 3-D image on the see-through display may also avoid having the operator's eyes refocus between the image on the display and the view outside the windows in the operator's line of sight.

The VES 110 may be configured to provide a continuous, surround view image on all or some of the interior surfaces of the cab in order to create a perceived 3-D surround view that is updated in real time to the operator. The VES 110 may include display software or programming configured to translate requests to display at least some of the information from the various devices 12 and cameras 14 in graphical representations of the information. Operator eye location sensing devices such as the operator-facing cameras 15 may approximate a location and/or direction of the head of an operator 7 in the cab 13 of the machine 10 as well as the orientation or gaze attributes of the eyes of the operator 7. Based upon the output of the operator eye location sensing system, the current location and orientation of the machine 10, and a user input location, the VES 110 may accurately and dynamically register the graphical representations on a HUD or on any one or more of the see-through displays formed by one or more of the windows in the cab 13. The projected graphical representations may further highlight projected images of objects or persons that would otherwise be blocked from view by portions of the machine. These projected images may be overlaid with visual images seen through the glass windows of the cab.

Information can be presented to the operator of the machine according to a number of exemplary embodiments. A number of video devices can be utilized to present information to the user. However, presenting the information within a context for the operator of a view of the operation environment of the machine reduces visual complexity for control of the machine. A graphic projection display can also be used to display graphics in the context of a view on any side of the machine. A graphic projection display and the associated graphics can be utilized according to a number of exemplary embodiments. When an image and any associated graphics are projected upon the see-through display glass used as one or more windows in the cab, certain wavelengths of light are reflected back to the operator. However, this reflected light does not interfere with the operator seeing through the windows. For example, the operator can still see the outline or greyed-out portions of the machine in the operator's line of sight, while at the same time seeing an object or person that is blocked from direct view by the portions of the machine. The object or person blocked from direct view may be displayed as a 3-D image on the see-through display. The operator may perceive the projected image of the object or person as though actually seeing through the blocking portions of the machine. This perception of seeing through the blocking portions of the machine may be enhanced as a result of the projected image appearing in 3-D. The perception of a 3-D image may be obtained through the use of passive, polarized, stereovision glasses worn by the operator, or through other autostereoscopic techniques that do not require special headgear or glasses. These autostereoscopic techniques may accommodate motion parallax and wider viewing angles through the use of gaze tracking and projection of multiple views. In addition, graphics such as a bounding box outlining and highlighting the object or person may be superimposed upon the projected image in order to further enhance visibility to the operator.

The machine 10 may include one or more vision tracking components, such as the operator-facing cameras 15 mounted within the cab 13 of the machine 10. The vision tracking components may be configured to implement techniques to enhance an experience associated with a field of view of a local environment. In general, the one or more vision tracking components may monitor physical characteristics as well as other features associated with an eye or eyes of a machine operator. Based upon these monitored features, a set of gaze attributes may be constructed. Gaze attributes may include an angle of rotation or a direction of an eye with respect to the head of the operator, an overall direction of the head of the operator, a diameter of the pupil of the eye, a focus distance, a current volume or field of view, and so forth. In one or more exemplary implementations the vision tracking component may tailor gaze attributes to a particular operator's eye or eyes. For example, machine learning may be employed to adjust or adapt to personal characteristics such as iris color (e.g., relative to the pupil), a shape of the eye or associated features, known or determined deficiencies, or the like.

In some alternative implementations, VES 110 may also be configured to include recognition components that can, among other things, obtain gaze attributes, indication of location, indication of perspective (or direction), and employ these obtained data to determine or identify a modeled view of a geospatial model (not shown) of the physical world surrounding the machine. The geospatial model may be a spatially accurate model of the environment, and may be included in a data store associated with the VES 110. The modeled view may correspond to a current field of view 16 of the operator or of one or more of the outward-facing cameras 14. Indication of a location of the machine 10 may be based on a two-dimensional (2-D) or a three-dimensional (3-D) coordinate system, such as latitude and longitude coordinates (2-D) as well as a third axis of height or elevation. Likewise, indication of perspective may relate to a 3-D orientation for the operator or the machine. Both indications of location of the machine and perspective may be obtained from sensors operatively coupled to the detection and ranging interface 18 and/or the camera interface 20. Recognition components may be included in the VES 110 to map indications of location in the physical world to a corresponding point or location in the geospatial model. Indication of perspective may also be translated to indicate a base perspective or facing direction, which can identify which entities or objects of the geospatial model have physical counterparts in the direction the operator is facing at any particular point in time. When combined with data regarding gaze attributes of the operator, the recognition components may determine a real, physical, current field of view 16 of the operator 7 in the cab 13 of the machine 10. The modeled view may be updated in real time as any or all of the operator's location, perspective, or gaze attributes changes.

While the machine 10 is shown having eight devices 12 each responsible for a different quadrant of the actual environment around machine 10, and also four cameras 14, those skilled in the art will appreciate that the machine 10 may include any number of sensors, devices 12, and cameras 14, 15 arranged in any manner. For example, the machine 10 may include four devices 12 on each side of the machine 10 and/or additional cameras 14 located at different elevations or locations on the machine 10.

FIG. 2 is a diagrammatic illustration of an exemplary VES 110 that may be installed on the machine 10 to capture and process image data and object data in the actual environment surrounding the machine 10. The VES 110 may include one or more processing modules that, when combined, perform object detection, image processing, and image rendering. For example, the VES 110 may include the devices 12, the outward-facing cameras 14, the operator-facing cameras 15, the detection and ranging interface 18, the camera interface 20, one or more see-through displays 22, multiple image projectors (not shown), and a processor 26. While FIG. 2 shows the components of the VES 110 as separate blocks, those skilled in the art will appreciate that the functionality described below with respect to one component may be performed by another component, or that the functionality of one component may be performed by two or more components.

According to some embodiments, the modules of VES 110 may include logic embodied as hardware, firmware, a collection of software written in a programming language, or any combination thereof. The modules of VES 110 may be stored in any type of computer-readable medium, such as a memory device (e.g., random access, flash memory, and the like), an optical medium (e.g., a CD, DVD, BluRay®, and the like), firmware (e.g., an EPROM), or any other storage medium. The modules may be configured for execution by the processor 26 to cause the VES 110 to perform particular operations. The modules of the VES 110 may also be embodied as hardware modules and may include connected logic units, such as gates and flip-flops, and/or may include programmable units, such as programmable gate arrays or processors, for example.

In some aspects, before the VES 110 can process object data from the devices 12 and/or image data from the cameras 14, 15, the object and/or image data must first be converted to a format that is consumable by the modules of the VES 110. For this reason, the devices 12 may be connected to the detection and ranging interface 18, and the cameras 14, 15 may be connected to the camera interface 20. The detection and ranging interface 18 and the camera interface 20 may each receive analog signals from their respective devices, and convert them to digital signals that may be processed by the other modules of the VES 110.

The detection and ranging interface 18 and/or the camera interface 20 may package the digital data in a data package or data structure, along with metadata related to the converted digital data. For example, the detection and ranging interface 18 may create a data structure or data package that has metadata and a payload. The payload may represent the object data from the devices 12. Non-exhaustive examples of the metadata may include the orientation of the device 12, the position of the device 12, and/or a time stamp for when the object data was recorded. Similarly, the camera interface 20 may create a data structure or data package that has metadata and a payload representing image data from the camera 14. This metadata may include parameters associated with the camera 14 that captured the image data. Non-exhaustive examples of the parameters associated with the camera 14 may include the orientation of the camera 14, the position of the camera 14 with respect to the machine 10, the down-vector of the camera 14, the range of the camera's field of view 16, a priority for image processing associated with each camera 14, and a time stamp for when the image data was recorded. Parameters associated with each camera 14 may be stored in a configuration file, database, data store, or some other computer readable medium accessible by the camera interface 20. The parameters may be set by an operator prior to operation of the machine 10.

In some embodiments, the devices 12 and/or the cameras 14 may be digital devices that produce digital data, and the detection and ranging interface 18 and the camera interface 20 may package the digital data into a data structure for consumption by the other modules of the VES 110. The detection and ranging interface 18 and the camera interface 20 may include an application program interface (API) that defines functionalities independent of their respective implementations, allowing the other modules of VES 110 to access the data.

Based on the object data from the detection and ranging interface 18, the processor 26 may be configured to detect objects in the actual environment surrounding the machine 10. The processor 26 may access object data by periodically polling the detection and ranging interface 18 for the data. The processor 26 may also or alternatively access the object data through an event triggered by the detection and ranging interface 18. For example, when a device 12 detects an object larger than a threshold size, it may generate a signal that is received by the detection and ranging interface 18, and the detection and ranging interface 18 may publish an event indicating detection of a large object. The processor 26, having registered for the event, may responsively receive the object data and analyze the payload of the object data. In addition to the orientation and position of the device 12 that detected the object, the payload of the object data may also indicate a location within the field of view 16 where the object was detected. For example, the object data may indicate the distance and angular position of the detected object relative to a known location of machine 10.

The processor 26 may combine image data received from the multiple cameras 14 via the camera interface 20 into a unified image 27. The unified image 27 may represent all image data available for the actual environment of the machine 10, and the processor 26 may stitch the images from each camera 14 together to create a 360-degree, 3-D view of the actual environment surrounding the machine 10. The machine 10 may be at a center of the 360-degree view in the unified image 27.

The processor 26 may be configured to use parameters associated with individual cameras 14 to create the unified image 27. The parameters may include, for example, the position of each camera 14 onboard the machine 10, as well as a size, shape, location, and/or orientation of the corresponding field of view 16. The processor 26 may then correlate sections of the unified image 27 with the camera locations around the machine 10, and/or the gaze direction or other gaze attributes of the operator 7, and use the remaining parameters to determine where to place the image data from each camera 14. For example, the processor 26 may correlate a forward section of the actual environment with the front of the machine 10 when the operator is looking in a forward direction, and also with a particular camera 14 pointing in that direction. Then, when the processor 26 subsequently receives image data from that camera 14, the processor 26 may determine that the image data should be mapped to the particular section of the unified image 27 corresponding to the front of machine 10. Thus, as the processor 26 accesses image data from each of the cameras 14, the processor 26 can correctly stitch it in the right section of the unified image 27.

In some applications, the images captured by the different cameras 14 may overlap somewhat, and the processor 26 may need to discard some image data in the overlap region in order to enhance clarity. Any strategy known in the art may be used for this purpose. For example, the cameras 14 may be prioritized based on type, location, age, functionality, quality, definition, etc., and the image data from the camera 14 having the lower priority may be discarded from the overlap region. In another example, the image data produced by each camera 14 may be continuously rated for quality, and the lower quality data may be discarded. Other strategies may also be employed for selectively discarding image data. It may also be possible to retain and use the overlapping composite image, if desired.

In various implementations, the processor 26 may be configured to generate a virtual three-dimensional surface or other geometry 28, and mathematically project the digital image data associated with the unified image 27 onto the geometry 28 to create a unified 3-D surround image of the machine environment. The digital image data associated with the unified image 27 may be derived from actual, real-time measurements and video images of the environment surrounding the machine 10 at any point in time. The geometry 28 may be generally hemispherical, with the machine 10 being located at an internal pole or center. The geometry 28 may be created to have any desired parameters, for example a desired diameter, a desired wall height, etc. The processor 26 may mathematically project the unified image 27 onto the geometry 28 by transferring pixels of the 2-D digital image data to 3-D locations on the geometry 28 using a predefined pixel map or look-up table stored in a computer readable data store or configuration file that is accessible by the processor 26. The digital image data may be mapped directly using a one-to-one or a one-to-many correspondence. Although a look-up table is one method by which processor 26 may create a 3-D surround view of the actual environment of machine 10, those skilled in the relevant art will appreciate that other methods for mapping image data may be used to achieve a similar effect.

In some instances, for example when large objects exist in the near vicinity of the machine 10, the image projected onto the geometry 28 could have distortions at the location of the objects. The processor 26 may be configured to enhance the clarity of the unified image 27 at these locations by selectively altering the geometry 28 used for projection of the unified image 27 (i.e., by altering the look-up table used for the mapping of the 2-D unified image 27 into 3-D space). In particular, the processor 26 may be configured to generate virtual objects 30 within the geometry 28 based on the object data captured in real time by the devices 12. The processor 26 may generate the virtual objects 30 of about the same size as actual objects detected in the actual environment of machine 10, and mathematically place the objects 30 at the same general locations within the hemispherical virtual geometry 28 relative to the location of the machine 10 at the pole. The processor 26 may then project the unified image 27 onto the object-containing virtual geometry 28. In other words, the processor 26 may adjust the lookup table used to map the 2-D image into 3-D space to account for the objects. As described above, this may be done for all objects larger than a threshold size, so as to reduce computational complexity of the VES 110.

The processor 26 may be configured to render a portion of the unified image 27 on the see-through display 22, consisting of one or more glass windows of the cab 13, after projection of the image 27 onto the virtual geometry 28. The portion rendered by the processor 26 may be automatically selected or manually selected, as desired. For example, the portion may be automatically selected based on a travel direction of machine 10. In particular, when the machine 10 is traveling forward, a front section of the as-projected unified image 27 may be shown on the display 22. And when machine 10 is traveling backward, a rear section may be shown. Additionally or alternatively, the portion of the unified image 27 rendered on the see-through display 22 may correlate directly with the direction of the gaze of the operator 7 of the machine 10 or other gaze attributes of the operator at any particular point in time.

### INDUSTRIAL APPLICABILITY

The disclosed vision enhancement system (VES 110) may be applicable to any machine that includes cameras and detection and ranging devices, and windows that form see-through displays. The disclosed system may enhance a surround view provided to the operator of the machine from the cameras by displaying a 3-D image of objects or personnel hidden from direct view by portions of the machine and superimposing that 3-D image on the portion of a window through which the operator is looking. Presentation of the surround view image on the see-through displays as a 3-D image may provide a realistic perception of where any hidden objects or personnel are located without the operator's eyes having to refocus between the display and the view outside of the window. The disclosed vision enhancement system may also generate a hemispherical virtual geometry, including virtual objects at detected locations of actual objects in the actual environment. The disclosed system may then mathematically project a unified image (or collection of individual images) onto the virtual geometry including virtual objects and bounded representations of personnel, if present, and render the resulting projection on the see-through displays that form windows of the cab of the machine.

Because the disclosed vision enhancement system may project actual 3-D images of real objects or virtual objects representative of real objects as located on a hemispherical virtual geometry, a greater depth perception may be realized in the resulting projection. This greater depth perception may reduce the amount of distortion and parallax demonstrated in the surround view than would otherwise result. The effect is to provide the operator of the machine with immediate and actionable information on all objects and personnel located around the machine at all times, whether blocked from view by portions of the machine or not. In various implementations of this disclosure, data regarding various obstacles, other machines or vehicles, and personnel located in the environment surrounding the machine may be gathered by various sensors and cameras on the machine, and/or supplied to the vision enhancement system from other sources offboard the machine.

Data regarding gaze attributes of the operator in a cab of the machine may also be supplied to the vision enhancement system by operator-facing cameras mounted in the cab. One or more windows of the cab may be replaced with see-through displays, which may be manufactured with various impurities in the glass such that only certain wavelengths of light are reflected by the glass. The see-through glass displays allow the operator to see clearly outside of the cab, while at the same time providing a display surface on which 3-D images may be projected by one or more projection devices within the cab. The 3-D images projected on the see-through displays may be perceived without the operator's eyes having to refocus on the displays to see the projected images while looking through the see-through displays at the environment outside of the cab. The 3-D effect may be achieved in part by the operator wearing passive, stereovision glasses, or in some cases through other autostereoscopic techniques that accommodate motion parallax and perspective without the operator having to wear glasses. The combined result of the see-through display glass windows, the operator gaze tracking input, the surround view projection, the graphics projection for additional highlighting of objects and personnel, and the perceived 3-D image of hidden objects superimposed on the operator's view through the windows is improved safety and enhanced visibility of all of the machine's surroundings.

It will be apparent to those skilled in the art that various modifications and variations can be made to the disclosed vision enhancement system. Other embodiments will be apparent to those skilled in the art from consideration of the specification and practice of the disclosed vision enhancement system. It is intended that the specification and examples be considered as exemplary only, with a true scope being indicated by the following claims and their equivalents.

What is claimed is:

1. A system for displaying machine surroundings to an operator in a cab of the machine, the system comprising:
at least one outward-facing camera mounted on the machine, the at least one outward-facing camera configured to generate image data for an actual environment surrounding the machine;
at least one operator-facing camera mounted within the cab of the machine, the at least one operator-facing camera configured to determine gaze attributes of the operator;
a sensor mounted on the machine and configured to generate object data regarding detection and ranging of an object in the actual environment;
at least one see-through display forming one or more windows of the cab of the machine; and
a processor in communication with the at least one outward-facing camera, the at least one operator-facing camera, and the sensor, the processor being configured to:
generate a unified image of the actual environment based on the image data; and
project the unified image as a 3-D image on the at least one see-through display.

2. The system of claim 1, further including multiple image projectors mounted within the cab of the machine and configured to project multiple images that form the unified image onto the at least one see-through display.

3. The system of claim 1, wherein the processor is further configured to:
generate a virtual geometry;
generate a virtual object within the virtual geometry based on the object data;
map a projection of the unified image onto the virtual geometry and the virtual object; and
render a selected portion of the projection on the at least one see-through display.

4. The system of claim 3, wherein the virtual geometry is hemispherical.

5. The system of claim 3, wherein the selected portion of the projection that is rendered on the see-through display is automatically selected based on at least one of a travel direction of the machine and the gaze attributes of the operator.

6. The system of claim 1, wherein the processor is further configured to project multiple views to form the unified 3-D image on portions of the at least one see-through display as determined by the gaze attributes of the operator.

7. The system of claim 1, further including passive, stereovision glasses configured to be worn by the operator in order to perceive the 3-D image on the at least one see-through display.

8. The system of claim 1, further including a graphics projection system configured to display graphics in the context of a view on any side of the machine.

9. The system of claim 8, wherein the graphics projection system is configured to display a bounding box outlining and highlighting an image of an object or person being projected onto the at least one see-through display.

10. A method of displaying machine surroundings to an operator in a cab of the machine, the method comprising:
generating image data for an actual environment surrounding the machine using at least one outward-facing camera mounted on the machine;
determining gaze attributes of the operator using at least one operator-facing camera mounted within the cab of the machine;
generating object data indicative of detection and range of an object in the actual environment using a sensor mounted on the machine;
generating a unified image of the actual environment based on the image data using a processor communicatively coupled to the at least one outward-facing camera, the at least one operator-facing camera, and the sensor; and
projecting the unified image as a 3-D image on at least one see-through display forming one or more windows of the cab of the machine.

11. The method of claim 10, further including projecting multiple images that form the unified image onto the at least one see-through display using multiple image projectors mounted within the cab of the machine.

12. The method of claim 10, further including:
generating a virtual geometry using the processor;
generating a virtual object within the virtual geometry based on the object data using the processor;
mapping a projection of the unified image onto the virtual geometry and the virtual object using the processor; and
rendering a selected portion of the projection on the at least one see-through display using the processor.

13. The method of claim 12, wherein the processor generates a hemispherical virtual geometry.

14. The method of claim 12, further including automatically selecting, using the processor, the selected portion of the projection that is rendered on the see-through display based on a travel direction of the machine.

15. The method of claim 10, further including projecting, using the processor, multiple views to form the unified 3-D image on portions of the at least one see-through display as determined by the gaze attributes of the operator.

16. The method of claim 10, further including viewing the projected, unified image on the at least one see-through display using passive, stereovision glasses in order to perceive the unified image as a 3-D image on the at least one see-through display.

17. The method of claim 10, further including displaying graphics on the at least one see-through display superimposed upon the unified image using a graphics projection system.

18. The method of claim 17, further including displaying a bounding box outlining and highlighting an image of an object or person being projected as part of the unified image onto the at least one see-through display.

19. A computer programmable medium having executable instructions stored thereon for completing a method of displaying machine surroundings to an operator in a cab of the machine, the method comprising:
generating image data for an actual environment surrounding the machine using at least one outward-facing camera mounted on the machine;
determining gaze attributes of the operator using at least one operator-facing camera mounted within the cab of the machine;
generating object data indicative of detection and range of an object in the actual environment using a sensor mounted on the machine;
generating a unified image of the actual environment based on the image data, the gaze attributes of the operator, and the object data; and
projecting the unified image as a 3-D image on at least one see-through display forming one or more windows of the cab of the machine.

20. The computer programmable medium of claim 19, further including executable instructions stored thereon for:
generating a virtual geometry;
generating a virtual object within the virtual geometry based on the object data;
mapping a projection of the unified image onto the virtual geometry and the virtual object; and
rendering a selected portion of the projection on the at least one see-through display based at least in part on one or more of the travel direction of the machine and the gaze attributes of the operator.
